(19) United States
(12) Patent Application Publication
(10) Pub. No.: US 2023/0343036 A1
(43) Pub. Date: Oct. 26, 2023

(54) MERGING MULTIPLE ENVIRONMENTS TO CREATE AN EXTENDED REALITY ENVIRONMENT

(71) Applicant: AT&T Intellectual Property I, L.P., Atlanta, GA (US)

(72) Inventors: Tan Xu, Bridgewater, NJ (US); Brian Novack, St. Louis, MO (US); Eric Zavesky, Austin, TX (US); Rashmi Palamadai, Naperville, IL (US)

(21) Appl. No.: 17/660,018

(22) Filed: Apr. 20, 2022

(51) Int. Cl. G06T 19/00; G06T 19/20

(52) U.S. Cl. CPC G06T 19/006; G06T 19/20

(57) ABSTRACT

In one example, a method performed by a processing system including at least one processor includes acquiring a virtual item to be inserted into a target environment to create an extended reality environment, detecting conditions within the target environment, merging the virtual item and the target environment to create the extended reality environment, wherein the merging includes modifying at least one of: the virtual item or the target environment based on the conditions within the target environment, and presenting the extended reality environment to a user.

The present disclosure relates generally to extended reality (XR) systems, and relates more particularly to devices, non-transitory computer-readable media, and methods for merging multiple environments to create a single, cohesive extended reality environment.

### BACKGROUND

Extended reality (XR) is an umbrella term that has been used to refer to various different forms of immersive technologies, including virtual reality (VR), augmented reality (AR), mixed reality (MR), cinematic reality (CR), and diminished reality (DR). Generally speaking, XR technologies allow virtual world (e.g., digital) objects from the metaverse to be brought into “real” (e.g., non-virtual) world environments and real world objects to be brought into virtual environments, e.g., via overlays or other mechanisms. Within this context, the term “metaverse” is typically used to describe the convergence of a virtually enhanced physical reality and a persistent virtual space, e.g., a physically persistent virtual space with persistent, shared, three-dimensional virtual spaces linked into a perceived virtual universe. XR technologies may have applications in fields including architecture, sports training, medicine, real estate, gaming, television and film, engineering, travel, and others. As such, immersive experiences that rely on XR technologies are growing in popularity.

### SUMMARY

In one example, the present disclosure describes a device, computer-readable medium, and method for enhancing user engagement with extended reality (XR) environments by merging multiple environments to create a single, cohesive extended reality environment. For instance, in one example, a method performed by a processing system including at least one processor includes acquiring a virtual item to be inserted into a target environment to create an extended reality environment, detecting conditions within the target environment, merging the virtual item and the target environment to create the extended reality environment, wherein the merging includes modifying at least one of: the virtual item or the target environment based on the conditions within the target environment, and presenting the extended reality environment to a user.

In another example, a non-transitory computer-readable medium stores instructions which, when executed by a processing system, including at least one processor, cause the processing system to perform operations. The operations include acquiring a virtual item to be inserted into a target environment to create an extended reality environment, detecting conditions within the target environment, merging the virtual item and the target environment to create the extended reality environment, wherein the merging includes modifying at least one of: the virtual item or the target environment based on the conditions within the target environment, and presenting the extended reality environment to a user.

In another example, a device includes a processing system including at least one processor and a computer-readable medium storing instructions which, when executed by the processing system, cause the processing system to perform operations. The operations include acquiring a virtual item to be inserted into a target environment to create an extended reality environment, detecting conditions within the target environment, merging the virtual item and the target environment to create the extended reality environment, wherein the merging includes modifying at least one of: the virtual item or the target environment based on the conditions within the target environment, and presenting the extended reality environment to a user.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure may operate;

FIG. 2 illustrates a flowchart of an example method for merging multiple environments to create a single extended reality environment in accordance with the present disclosure;

FIG. 3, for instance, illustrates an example of the use of keyframes to present an extended reality environment; and

FIG. 4 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure enhances the immersion of extended reality (XR) environments by merging multiple environments to create a single, cohesive extended reality environment. As discussed above, XR technologies allow virtual world (e.g., digital) objects from the metaverse to be brought into “real” (e.g., non-virtual) world environments and real world objects to be brought into virtual environments, e.g., via overlays in a display, projection, hologram, or other mechanisms. This creates a more engaging and immersive experience for users. For instance, an XR environment could provide a 360 degree rendering of a famous landmark, allowing a user to change viewing perspective with six degrees of freedom, so that the user feels like they are physically present at the landmark by simply putting on a head mounted display. However, virtual objects that are rendered for insertion into real or virtual environments are often created in a vacuum, without reference to the environment into which they are being inserted. As a result, the virtual objects may not “blend” realistically with their surrounding environment. This disconnect between the virtual objects and their corresponding environment may detract from the immersive experience of the extended environment.

Examples of the present disclosure provide a system that improves the merging of virtual objects with a real or virtual environment to create an extended reality environment. In one example, sensors may be used to collect information about the target environment into which a virtual object is to be inserted. This information may include, for instance, information about the target environment’s appearance (e.g., layout, topography, presence and locations of objects and surfaces, etc.) and information about the current environmental conditions in the target environment (e.g., lighting, wind, weather, sounds, smells, etc.). This information about the target environment may then be used to alter the presentation of at least one of the target environment or the virtual object, so that the virtual object and the target environment are merged more seamlessly into the extended reality environment.

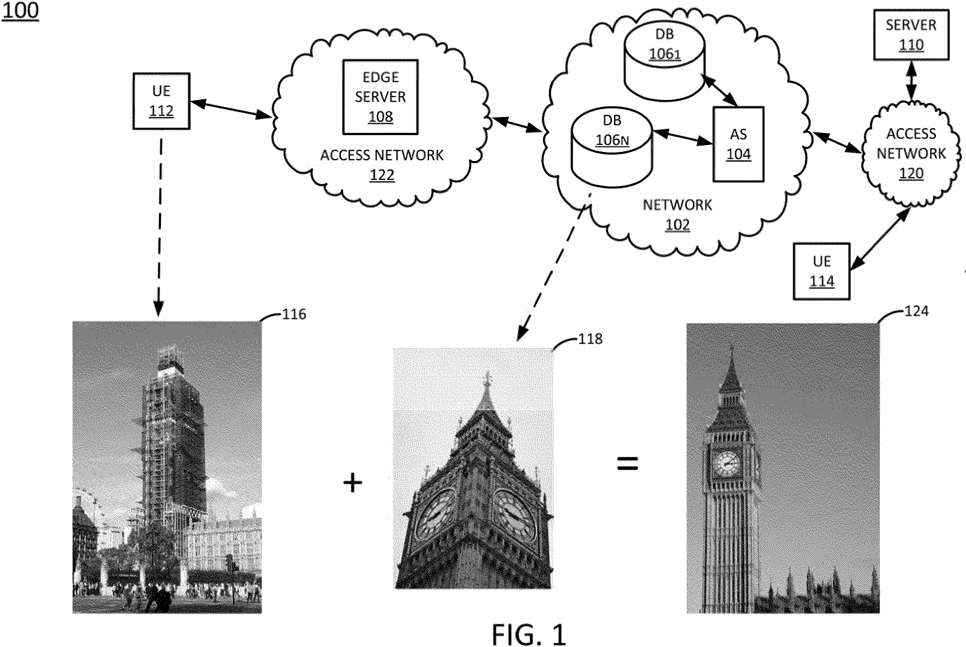

In further examples, historical and/or recorded information (as opposed to current or real time information) about the target environment may be leveraged to alter the virtual object and/or the target environment in a manner that considers the specific space (e.g., location) and time (e.g., temporal effects) for the placement of the virtual object in a target environment. For instance, if the target environment depicts a real world environment as the real world environment looked fifty years ago, historical records about the real world environment’s appearance fifty years ago could be used to alter a virtual object in a period appropriate manner or to alter an appearance of the target environment to better match the historical records. These and other aspects of the present disclosure are described in greater detail below in connection with the examples of FIGS. 1-4.

To further aid in understanding the present disclosure, FIG. 1 illustrates an example system 100 in which examples of the present disclosure may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, and the like), a long term evolution (LTE) network, 5G and the like related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a network 102, e.g., a telecommunication service provider network, a core network, or an enterprise network comprising infrastructure for computing and communications services of a business, an educational institution, a governmental service, or other enterprises. The network 102 may be in communication with one or more access networks 120 and 122, and the Internet (not shown). In one example, network 102 may combine core network components of a cellular network with components of a triple play service network; where triple-play services include telephone services, Internet or data services and television services to subscribers. For example, network 102 may functionally comprise a fixed mobile convergence (FMC) network, e.g., an IP Multimedia Subsystem (IMS) network. In addition, network 102 may functionally comprise a telephony network, e.g., an Internet Protocol/Multi-Protocol Label Switching (IP/MPLS) backbone network utilizing Session Initiation Protocol (SIP) for circuit-switched and Voice over internet Protocol (VoIP) telephony services. Network 102 may further comprise a broadcast television network, e.g., a traditional cable provider network or an internet Protocol Television (IPTV) network, as well as an Internet Service Provider (ISP) network. In one example, network 102 may include a plurality of television (TV) servers (e.g., a broadcast server, a cable head-end), a plurality of content servers, an advertising server (AS), an interactive TV/ video on demand (VoD) server, and so forth.

In one example, the access networks 120 and 122 may comprise broadband optical and/or cable access networks, Local Area Networks (LANs), wireless access networks (e.g., an IEEE 802.11/Wi-Fi network and the like), cellular access networks, Digital Subscriber Line (DSL) networks, public switched telephone network (PSTN) access networks, 3^{rd} party networks, and the like. For example, the operator of network 102 may provide a cable television service, an IPTV service, or any other types of telecommunication service to subscribers via access networks 120 and 122. In one example, the access networks 120 and 122 may comprise different types of access networks, may comprise the same type of access network, or some access networks may be the same type of access network and other may be different types of access networks. In one example, the network 102 may be operated by a telecommunication network service provider. The network 102 and the access networks 120 and 122 may be operated by different service providers, the same service provider or a combination thereof, or may be operated by entities having core businesses that are not related to telecommunications services, e.g., corporate, governmental or educational institution LANs, and the like.

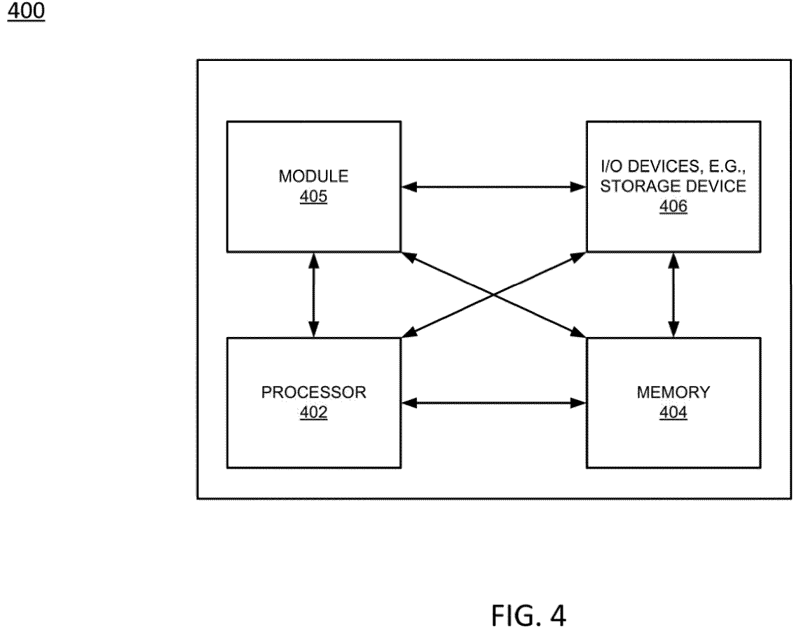

In accordance with the present disclosure, network 102 may include an application server (AS) 104, which may comprise a computing system or server, such as computing system 400 depicted in FIG. 4, and may be configured to provide one or more operations or functions in connection with examples of the present disclosure for merging multiple environments to create a single, cohesive extended reality environment. The network 102 may also include one or more databases (DBs) 106₁-106_{N} (hereinafter individually referred to as a “DB 106” or collectively referred to as “DBs 106”) that are communicatively coupled to the AS 104. For instance, one of the DBs 106 may contain one or more instances of virtual items, while another of the DBs 106 may contain historical data for specific real world environments, and another of the DBs 106 may contain other data.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure. Thus, although only a single application server (AS) 104 and two databases (DBs) 106 are illustrated, it should be noted that any number of servers and any number of databases may be deployed. Furthermore, these servers and databases may operate in a distributed and/or coordinated manner as a processing system to perform operations in connection with the present disclosure.

In one example, AS 104 may comprise a centralized network-based server for generating extended reality environments. For instance, the AS 104 may host an application that renders immersive extended reality environments which are accessible by users utilizing various user endpoint devices. In one example, the AS 104 may be configured to merge virtual items with a target environment in a manner that creates a single, cohesive extended reality environment. For instance, the AS 104 may detect conditions within the target environment, where the conditions may comprise current conditions (e.g., as inferred from sensor data collected by one or more sensors within the target environment and/or from historical data relating to the target environment) or historical conditions (e.g., as inferred from historical data relating to the target environment). Based on the detected conditions, the AS 104 may modify a virtual item to be merged with the target environment and/or may modify elements of the target environment so that the virtual item can be incorporated into the target environment in a seamless and realistic manner that does not detract from the immersive feel of the resultant extended reality environment.

In one example, AS 104 may comprise a physical storage device (e.g., a database server) to store a pool of virtual items. The pool of virtual items may comprise both immersive and non-immersive items of media content, such as still images, video (e.g., two dimensional video, three-dimensional video, 360 degree video, volumetric video, etc.), audio, three-dimensional models, and the like. The pool of virtual items may include licensed content (e.g., three-dimensional models, images, or audio clips of famous vehicles, characters, or buildings) as well as content that has been created and/or modified by users (e.g., virtual items that have been modified by users of past extended reality environments for specific conditions, purposes, or the like).

In one example, one or more of the DBs 106 may store the pool of virtual items, and the AS 104 may retrieve individual virtual items from the DB(s) 106 when needed. For ease of illustration, various additional elements of network 102 are omitted from FIG. 1.

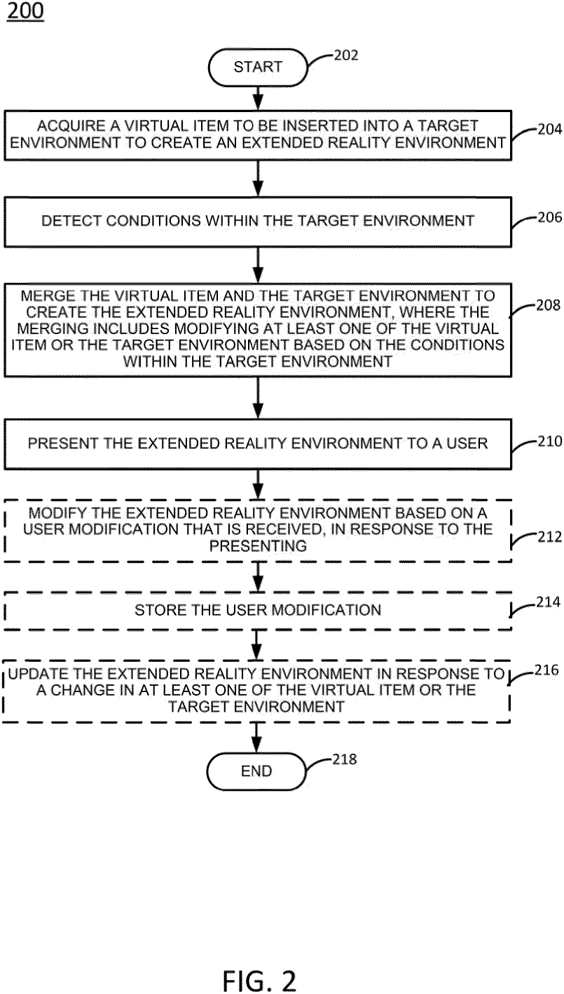

In one example, access network 122 may include an edge server 108, which may comprise a computing system or server, such as computing system 400 depicted in FIG. 4, and may be configured to provide one or more operations or functions for merging multiple environments to create a single, cohesive extended reality environment, as described herein. For instance, an example method 200 for merging multiple environments to create a single, cohesive extended reality environment is illustrated in FIG. 2 and described in greater detail below.

In one example, application server 104 may comprise a network function virtualization infrastructure (NFVI), e.g., one or more devices or servers that are available as host devices to host virtual machines (VMs), containers, or the like comprising virtual network functions (VNFs). In other words, at least a portion of the network 102 may incorporate software-defined network (SDN) components. Similarly, in one example, access networks 120 and 122 may comprise “edge clouds,” which may include a plurality of nodes/host devices, e.g., computing resources comprising processors, e.g., central processing units (CPUs), graphics processing units (GPUs), programmable logic devices (PLDs), such as field programmable gate arrays (FPGAs), or the like, memory, storage, and so forth. In an example where the access network 122 comprises radio access networks, the nodes and other components of the access network 122 may be referred to as a mobile edge infrastructure. As just one example, edge server 108 may be instantiated on one or more servers hosting virtualization platforms for managing one or more virtual machines (VMs), containers, microservices, or the like. In other words, in one example, edge server 108 may comprise a VM, a container, or the like.

In one example, the access network 120 may be in communication with a server 110. Similarly, access network 122 may be in communication with one or more devices, e.g., a user endpoint device 112, and access network 122 may be in communication with one or more devices, e.g., a user endpoint device 114. Access networks 120 and 122 may transmit and receive communications between server 110, user endpoint devices 112 and 114, application server (AS) 104, other components of network 102, devices reachable via the Internet in general, and so forth. In one example, the user endpoint devices 112 and 114 may comprise mobile devices, cellular smart phones, wearable computing devices (e.g., smart glasses, virtual reality (VR) headsets or other types of head mounted displays, or the like), laptop computers, tablet computers, Internet of Things (IoT) devices, or the like (broadly “extended reality devices”). In one example, each of the user endpoint devices 112 and 114 may comprise a computing system or device, such as computing system 400 depicted in FIG. 4, and may be configured to provide one or more operations or functions in connection with examples of the present disclosure for merging multiple environments to create a single, cohesive extended reality environment.

In one example, server 110 may comprise a network-based server for generating extended reality environments. In this regard, server 110 may comprise the same or similar components as those of AS 104 and may provide the same or similar functions. Thus, any examples described herein with respect to AS 104 may similarly apply to server 110, and vice versa. In particular, server 110 may be a component of an extended reality system operated by an entity that is not a telecommunications network operator. For instance, a provider of an extended reality system may operate server 110 and may also operate edge server 108 in accordance with an arrangement with a telecommunication service provider offering edge computing resources to third-parties. However, in another example, a telecommunication network service provider may operate network 102 and access network 122, and may also provide an extended reality system via AS 104 and edge server 108. For instance, in such an example, the extended reality system may comprise an additional service that may be offered to subscribers, e.g., in addition to network access services, telephony services, traditional television services, and so forth.

In an illustrative example, an extended reality system may be provided via AS 104 and edge server 108. In one example, a user may engage an application on user endpoint device 112 (e.g., an “extended reality device”) to establish one or more sessions with the extended reality system, e.g., a connection to edge server 108 (or a connection to edge server 108 and a connection to AS 104). In one example, the access network 122 may comprise a cellular network (e.g., a 4G network and/or an LTE network, or a portion thereof, such as an evolved Uniform Terrestrial Radio Access Network (eUTRAN), an evolved packet core (EPC) network, etc., a 5G network, etc.). Thus, the communications between user endpoint device 112 and edge server 108 may involve cellular communication via one or more base stations (e.g., eNodeBs, gNBs, or the like). However, in another example, the communications may alternatively or additional be via a non-cellular wireless communication modality, such as IEEE 802.11/Wi-Fi, or the like. For instance, access network 122 may comprise a wireless local area network (WLAN) containing at least one wireless access point (AP), e.g., a wireless router. Alternatively, or in addition, user endpoint device 112 may communicate with access network 122, network 102, the Internet in general, etc., via a WLAN that interfaces with access network 122.

In the example of FIG. 1, user endpoint device 112 may establish a session with edge server 108 for accessing or joining or generating an extended reality environment that requires heavy computational or graphical resources beyond the hardware capacity of the user endpoint device 112 for low network latency. As discussed above, the extended reality environment may be generated by merging multiple environments to create a single, cohesive extended reality environment. The extended reality environment may, for instance, provide a rendering of a subject that is computed from big data and artificial intelligence models (e.g., computer vision for object recognition, spatial computing, and three-dimensional reconstruction), desired in high fidelity (e.g., real time rendered in 4K resolution and photorealism), viewable from multiple different perspectives, that is interactive, that allows for multiple possible branches or paths of exploration, or that may be modified to depict an appearance associated with a specific time, event, season, location, or the like.

As an example, a user may be viewing the Westminster Clock Tower in London through a pair of smart glasses (e.g., UE 112 of FIG. 1). However, the clock tower may currently be undergoing repairs, such that the view of the clock tower through the smart glasses is obscured by scaffolding. In the example illustrated in FIG. 1, the AS 104 may acquire from the user a stream of real time video 116 of the clock tower. In addition, the AS 104 may acquire from one or more of the databases 106 a three-dimensional model 118 of the clock tower without the scaffolding. Alternatively, instead of a three-dimensional model of the clock tower, the AS 104 could retrieve one or more historical images of the clock tower, where the historical images depict the clock tower without the scaffolding. The AS 104 may modify the three-dimensional model 118 (e.g., performing a geometry merge, scaling, rotating, texture mapping, and/or other operations) and then merge the modified three-dimensional model 118 with the real time video 116 to produce an extended reality environment 124 which the user may view through the smart glasses with high resolution and refresh rate stereo displays. When the extended reality environment 124 is viewed through the smart glasses, it may appear to the user as though the user is viewing the clock tower without the scaffolding in real time.

In other examples, the AS 104 may utilize historical data relating to the clock tower, such as the historical images of the clock tower, in order to modify the real time video 116 in a manner that removes the scaffolding from view. In other examples still, the AS 104 could use the historical data to construct a new three-dimensional model that can be merged into the real time video 116 as described above (e.g., rather than retrieve an existing three-dimensional model). Thus, the AS 104 may be configured to merge elements of two or more environments, where those elements may be real world items, virtual items, or a combination of real world and virtual items, in a manner that provides a realistic immersive experience.

It should also be noted that the system 100 has been simplified. Thus, it should be noted that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of network 102, access networks 120 and 122, and/or Internet may comprise a content distribution network (CDN) having ingest servers, edge servers, and the like for packet-based streaming of video, audio, or other content. Similarly, although only two access networks, 120 and 122 are shown, in other examples, access networks 120 and/or 122 may each comprise a plurality of different access networks that may interface with network 102 independently or in a chained manner. In addition, as described above, the functions of AS 104 may be similarly provided by server 110, or may be provided by AS 104 in conjunction with server 110. For instance, AS 104 and server 110 may be configured in a load balancing arrangement, or may be configured to provide for backups or redundancies with respect to each other, and so forth. Thus, these and other modifications are all contemplated within the scope of the present disclosure.

To further aid in understanding the present disclosure, FIG. 2 illustrates a flowchart of an example method 200 for merging multiple environments to create a single extended reality environment in accordance with the present disclosure. In particular, the method 200 provides a method by which an extended reality environment may be rendered by using current and/or historical data about a target (e.g., real or virtual) environment to alter a virtual object that is to be inserted into the target environment. In one example, the method 200 may be performed by an XR server that is configured to generate XR environments, such as the AS 104 or server 110 illustrated in FIG. 1. However, in other examples, the method 200 may be performed by another device, such as the processor 402 of the system 400 illustrated in FIG. 4. For the sake of example, the method 200 is described as being performed by a processing system.

The method 200 begins in step 202. In step 204, the processing system may acquire a virtual item to be inserted into a target environment to create an extended reality environment. In one example, the extended reality environment may comprise an immersive game, a real estate simulator, a training simulator, a virtual tour of a space (e.g., a museum or landmark), a navigation application, or any other immersive experiences that combine elements of two or more environments (where the two or more environments may comprise real environments, virtual environments, or combinations of real and virtual environments).

For instance, in one example, the target environment may comprise a real world environment. As an example, the real world environment may comprise a real world environment in which a user is currently present, such as a room in the user’s home or a friend’s home, an office, a classroom, a stadium, a performance space (e.g., a theater), a professional training area (e.g., for first responders, vehicle operators, or the like), a public space (e.g., a museum, a landmark, a city street, or the like), a commercial gaming environment (e.g., an arcade), or another type of environment. In another example, the target environment may comprise a virtual environment, or a digital twin of a real world environment.

In one example, the virtual item may comprise a single virtual object or an entire virtual environment comprising a plurality of virtual objects. In this case, a virtual object may comprise audio, video, still images, three-dimensional models, or any combination of audio, video, still images, and three-dimensional models. A virtual environment may thus comprise a plurality of virtual objects which may be visually or thematically related in order to collectively create a single cohesive impression.

In one example, the virtual item may comprise an existing (e.g., stored) virtual item. For instance, the virtual item may have been previously created for use in another extended reality environment and saved for reuse. In one example, the virtual item may comprise a digital twin of a real world object or environment. The digital twin may be stored, but updated over time to reflect actual changes to the real world object or item.

In another example, the virtual item may comprise a shared resource, such as audio, video, still images, three-dimensional models, or any combination of audio, video, still images, and three-dimensional models that a contact of the user has shared via social media (e.g., a photo or video). For instance, the user’s friend may have shared an image of a famous landmark on the friend’s social media profile. Alternatively, the virtual item may have been created by the user, either specifically for use in the extended reality environment or for some other purposes. In another example, the virtual item may comprise a reference for a real-world item that is known to change over time. For instance, instead of directly referencing the current president of a country, executive of a company, or marketing persona for a company, the virtual item may represent the concept of the president, executive, or marketing persona, which is known to change. During the preparation of the reference for presentation in the extended reality environment, the virtual item may be automatically updated to match the appropriate time and spatial context of the target environment.

The user may select the virtual item for incorporation into the extended reality environment, or the processing system may recommend that the virtual item be incorporated. A recommendation to incorporate a virtual item into an extended reality environment may be based on the current context of the extended reality environment (e.g., if the user is currently engaged in a multiplayer battle of an immersive game, the virtual item might comprise a weapon; if the user is currently viewing an artifact during a virtual museum tour, the virtual item might comprise a video of a docent presenting information about the artifact). The recommendation may also be based on knowledge of the user’s interests, which may be determined by retrieving a profile for the user. In one example of an augmentation, if the user is viewing a home for sale and enjoys swimming, the virtual item might comprise a three-dimensional model of a swimming pool placed in the home’s yard so that the user might visualize what the yard would look like with a pool. In another example of a diminishment, if the user is viewing a landmarked field or bluff and wishes to view the environment of a historical battleground, the instances of modern structures (e.g., bathrooms, billboards, highways, etc.) may be visually removed or replaced with virtual items that correspond to the environment setting (even if these virtual items do not have a specific historical analog recorded previously).

In step 206, the processing system may detect conditions within the target environment. In one example, the conditions may comprise current conditions with the target environment. For instance, if the target environment is a real world environment in which the user is currently present, then the current conditions within the target environment may be detected by analyzing data collected by one or more sensors. In one example, these sensors may include cameras (e.g., still or video cameras, RGB cameras, infrared cameras, etc.), thermometers, humidity sensors, weather sensors, motion sensors, microphones, satellites, and/or other sensors. These sensors may be integrated into a user endpoint device that the user uses to experience the extended reality environment (e.g., a head mounted display, a mobile phone, a haptic feedback device, etc.). These sensors may also be integrated into other devices that are located throughout the target environment, such as IoT devices (e.g., smart security systems, smart thermostats, smart lighting systems, etc.).

The conditions within the target environment may comprise, for example, the physical boundaries, dimensions, and layout of the target environment. For instance, the processing system may determine, based on data collected by the sensors, what the shape of the target environment is, how big the target environment is, whether there are any objects present in the target environment (such as furniture, walls, people or animals, vehicles, and/or other objects), where the objects are located, and/or other static or semi-static conditions. The conditions within the target environment may also comprise more dynamic conditions, such as the current environmental conditions (e.g., temperature, wind, humidity, precipitation, lighting, noise, etc.) within the target environment.

In another example, the conditions within the target environment may be estimated from historical data relating to the target environment. For instance, the processing system may identify the target environment, with user assistance (e.g., the user may specify the target environment as a particular location) and/or through processing of sensor data (e.g., the processing system may use image analysis, matching of global positioning system coordinates, or other techniques to identify a location corresponding to the target environment). Once the target environment is identified, the processing system may retrieve historical data relating to the target environment from one or more data sources. For instance, the processing system may utilize keywords relating to the target environment to search for data that is tagged with metadata matching the keywords. As an example, the processing system may identify the target environment as “Minute Maid Park” based on GPS coordinates placing the target environment on Crawford Street in Houston and/or on image analysis that detects identifying features of the stadium (e.g., the retractable roof, the train above left field, the Union Station lobby, a professional baseball team’s logo painted behind home plate, etc.). The processing system may then search one or more data sources for data tagged with metadata that matches keywords such as “Minute Maid Park” or semantically equivalent or related terms (e.g., “The Juice Box”).

Based on the retrieved historical data, the processing system may estimate the conditions within the target environment. For instance, if it is currently July 1, the processing system may estimate the current weather conditions within Houston based on historical weather conditions for Houston on July 1 of previous years. As an example, the current temperature in Houston may be estimated based on an average of the high temperature for Houston on July 1 for each of the previous ten years. Similarly, if the historical data indicates that July 1 in Houston tends to be rainy, then the processing system may estimate that it is currently rainy in Houston.

In another example, the conditions within the target environment may be estimated based on historical data relating to other environments that are similar to the target environment. For instance, the target environment may comprise a town in New England that includes a lot of Victorian architecture; however, there may be little or no historical information available for the town. As a result, the processing system may estimate the conditions within the target environment based on other New England towns that include Victorian architecture.

In one example the conditions within the target environment may be historical conditions rather than current conditions. For instance the user may specify that the target environment is a real world environment, but a historical version of the real world environment as opposed to a current version of the real world environment. For instance, the target environment may be the boardwalk in Seaside Heights, New Jersey pre-Hurricane Sandy, as opposed to the boardwalk in present day Seaside Heights post-Hurricane Sandy. In this case, historical information about the target environment, retrieved from one or more data sources, may form the basis for the target environment.

In one example, historical data relating to a target environment (or to an environment that is similar to the target environment) may comprise images (close-up images, street view images, satellite images, and the like), sound recordings (e.g., street noise, ambient sound, etc.), three-dimensional models (e.g., of objects present within the target environment), text (e.g., news reports), smells, and the like. In further examples, the historical data may depict what the target environment looked and/or felt like on a specific date in the past (e.g., during a notable event such as a parade or natural disaster), what the target environment looks and/or feels like during specific times of year (e.g., summer versus winter), or what the target environment looks and/or feels like under specific conditions (e.g., windy, blizzard, heatwave, etc.).

In step 208, the processing system may merge the virtual item and the target environment to create the extended reality environment, where the merging includes modifying at least one of: the virtual item or the target environment based on the conditions within the target environment.

In one example, modifying the virtual item or the target environment may comprise modifying an appearance of the virtual item or the target environment so that the virtual item and the target environment better blend with each other. For instance, the modification may comprise a geometry merge based on a placement location of the virtual item within the target environment. As an example, if the virtual item comprises a unique throne from a popular television series, and the target environment is the user’s living room, then the geometrical dimensions of the throne may be scaled to fit within the user’s living room (e.g., such that the throne is not taller than the ceiling of the living room, or wider than the walls, etc.).

In another example, the modification may comprise scaling the virtual item to replace an object in the target environment. For instance, referring again to the example in which the virtual item is a throne, if the throne is to be placed in the location of a reclining chair in the user’s living room, then the dimensions of the throne may be scaled to better match the dimensions of the reclining chair (e.g., so that the virtual throne may be superimposed over an image of the reclining chair without any portion of the reclining chair being visible).

In a further example, if the target environment includes objects whose appearance can be manipulated (e.g. the target environment is a virtual environment including a plurality of virtual objects), then the target environment and/or an existing object within the target environment may also be scaled or otherwise modified. For instance, if the target environment is a digital twin of the user’s living room, and the digital twin includes a three-dimensional model of the reclining chair, then the modification may comprise scaling the three-dimensional model of the reclining chair so that the reclining chair is not visible behind the throne, or even removing the three-dimensional model of the reclining chair from the digital twin (and replacing the three-dimensional model of the reclining chair with the virtual object of the throne).

In further examples, the modification may comprise performing a color adjustment or texture smoothing on the virtual item and/or portions of the target environment so that the transition from the virtual item to the target environment looks more natural.

In another example, the modification may comprise modifying the presentation of the target environment to match a specific date or time period (e.g., November 5, 1955, or simply autumn 1955), a specific time of day (e.g., 10:04 PM, or simply late evening), a specific event (e.g., the day that lightning struck a town clock tower), or the like. For instance, if the target environment comprises a virtual environment (or a digital twin of a real world environment), then elements of the target environment may be modified based on historical data to match the desired presentation. As an example, the hands of a clock may be modified to show a specific time, a banner that is currently present in the target environment but was not present in the desired presentation may be removed, a structure that was present in the desired presentation but has since been destroyed may be added back into the target environment, effects representing the weather during the desired presentation may be added into the target environment, and the like.

In step 210, the processing system may present the extended reality environment to a user. That is, the processing system may present the result of the merge operation performed in step 208 as a proposed extended reality environment for the user to review and approve. The extended reality environment may be presented on any device that is capable of presenting the extended reality environment, including a head mounted display, a mobile phone, or another device.

In one example, presenting the extended reality environment may include presenting “keyframes” or transformations of the extended reality environment along a timeline. That is, the extended reality environment may be presented in animation along with a graphical control (e.g., a slider bar or similar mechanism) that the user can manipulate in order to visualize changes in the extended reality environment over a period of time.

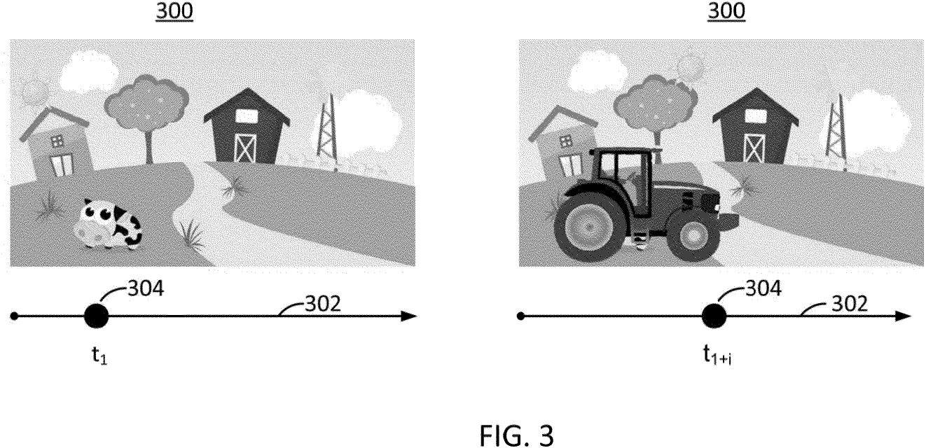

FIG. 3, for instance, illustrates an example of the use of keyframes to present an extended reality environment with animation. In the example illustrated, the extended reality environment comprises a farm. A view of the farm may be presented in a display area 300 of a user endpoint device or display. The graphical control in this example may comprise a timeline 302 that is positioned along the display area 300 (e.g., above or below the display area 300) and that has a length that corresponds to a predefined period of time (e.g., x minutes, y hours, etc.). A button 304 may be moveable by a user along the timeline 302. When the user moves the button 304 to a specific position on the timeline 302, the display area 300 may present a view of the extended reality environment that corresponds to the time associated with the specific position.

For instance, when the button 304 is moved to time t₁ on the timeline 302, the view of the extended reality environment that is presented is a morning scene. The sun is positioned low in the sky and to the left of the display area 300, and a cow is resting in the lower left corner of the display area 300. When the button 304 is moved to time t₁₊ᵢ on the timeline 302 that is some time later than t₁, the sun has moved higher in the sky and closer to the center of the display area 300. The cow is gone, and now a tractor has appeared in the lower left corner of the display area 300.

Without user manipulation of the graphical control (e.g., the timeline 302 and button 304), the changes in the extended reality environment may be able to play out sequentially at the speed in which the changes happened, similar to a sequence of animation. By manipulating the graphical control, the user may be able to control a speed of the change (e.g., slow motion, fast forward), a direction of the change (e.g., forward to go forward in time or backward to go back in time), and/or to pause on a selected moment along the timeline 302.

In one example, the processing system may tailor the presentation of the extended reality environment to the capabilities of the user’s endpoint device. For instance, the appearance of the extended reality environment may vary depending on the display capabilities (e.g., two-dimensional, three-dimensional, volumetric, 360 degree, etc.) of the endpoint device. In addition, the inclusion of additional sensory effects (e.g., tactile, olfactory, etc.) may depend on whether the endpoint device is capable of producing those effects (or capable of communicating with a proximate device that can produce the effects). In another example, the appearance of the extended reality environment (e.g., the resolution, refresh rate, or the like) may be tailored to the connectivity (e.g., signal strength, bandwidth, latency, etc.) of the endpoint device.

Referring back to FIG. 2, in optional step 212 (illustrated on phantom), the processing system may modify the extended reality environment based on a user modification that is received in response to the presenting. For instance, the user may view the extended reality environment presented in step 210 and may request one or more changes to the extended reality environment.

For instance, in one example, the user modification may comprise a request to modify an environmental effect in the extended reality environment. As an example, the extended reality environment may include a statute that is present in the real world, but that is partially covered in moss in the extended reality environment (where the moss may be included as a result of a prediction that is made based on an analysis of historical data relating to the statue). However, the user may request that the moss be removed from one side of the stature. In other examples, the user may request the addition, removal, or change of other environmental and/or visual effects. For instance, the user modification may comprise a change to a weather effect (e.g., add rain to the extended reality environment, reduce the intensity of rain that is already included in the extended reality environment, remove wind, etc.).

In another example, the user modification may comprise a request to modify a virtual object in the extended reality environment. As an example, the user may request that the material from which a piece of furniture is constructed (where the piece of furniture comprises a virtual object in the extended reality environment) be made to age more quickly or to deform in an unusual manner (e.g., in response to weather or time events of a specified nature). As an example, the color of the upholstery of a chair may be made to fade more quickly or to react to water in an unusual or unexpected manner.

In a further example where keyframes are presented with the extended reality environment, the user modification may comprise a request to modify the speed with which certain effects are applied to the extended reality environment’s timeline. For instance, the user may request that fifteen percent of the distortion in the extended reality environment that occurs over the timeline be made to occur within the first year covered by the timeline, while forty percent of the distortion be made to occur within the second year.

In a further example, in addition to modifying the speed with which changes are applied to an object in the extended reality environment, the user modification may also request that the initial and/or final appearance of the object be changed. For instance, the user may ask that the initial appearance of the object (i.e., prior to any change being applied, or at a starting time t₀ on the timeline) be modified. As an example, the initial appearance of a building appearing in the extended reality environment may be modified to remove a wall, a window, or the like. A change to the initial appearance of the object may cause the processing system to make corresponding changes in the extended reality environment further down the timeline (e.g., to carry the change through the period of time covered by the timeline and to potentially make further changes necessitated by the change to the initial appearance of the object).

In optional step 214, processing system may store the user modification. For instance, if the user modification comprised a modification to a specific environmental effect in a specific activity (e.g., aging of copper statue in humid environment), the modification can be saved for future reuse by the user or others in other extended reality environments. Similarly, if the user modification comprises a change to the color, texture, shape, or other aspects of the appearance of a three-dimensional model of a virtual object, the modified three-dimensional model may be saved for future reuse.

In one example, the user modification may be saved in a marketplace of virtual objects and effects that are available to users. This may allow users to monetize their modifications while sharing the modifications with others. For instance, content creators may create various versions of recognizable objects (e.g., a famous car from a movie, a famous character’s costume, etc.) which can be licensed by users and incorporated into different extended reality environments under different conditions.

In optional step 216, the processing system may update the extended reality environment in response to a change in at least one of the virtual item or the target environment. For instance, if the target environment or any virtual items merged with the target environment comprise a digital twin, the digital twin may be updated over time to reflect actual changes to the real world object which the digital twin emulates. Changes to the digital twin could then be replicated in the extended reality environment. Similarly, environmental conditions in the target environment could change to reflect the passage of time (e.g., day into night), transient weather conditions (e.g., sudden rainstorms), other users joining or exiting the extended reality environment, and the like. In one example, user approval may be solicited before applying any updates; however, in other examples, updates may be applied unless the user disables updates.

The method 200 may end in step 218. However, in some examples, steps of the method may be repeated before a signal is received that indicates that the user wishes for the processing system to cease presenting the extended reality environment (e.g., before the user powers down their endpoint device, speaks a command, or presses a button to exit the extended reality environment, or the like). For instance, the processing system may acquire new virtual items to be merged with the target environment, may receive new user modifications to the extended reality environment, may detect new changes to the virtual item and/or target environment, or the like.

Although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

The ability to seamlessly merge elements of two or more environments into a single, cohesive extended reality environment may enhance a plurality of immersive applications. For instance, in one example, examples of the present disclosure may be used to enhance real estate applications that provide virtual tours of homes. Examples of the present disclosure could merge real world views of a home (or views of a digital twin of the home) with virtual environmental effects to show what the home would look like in different seasons. Historical information about the home and location could be used to simulate the effects of different environmental conditions (e.g., to determine whether the home is prone to flooding during rain, whether trains travelling along nearby train tracks can be heard or felt within the home, whether odors from a nearby body of water can be smelled from the home, whether local humidity might affect a vehicle parked in the driveway, etc.).

Similarly, examples of the present disclosure could be used to virtually “remove” existing furniture and décor within the home and to seamlessly replace the furniture and décor with a potential new owner’s possessions (e.g., determine whether the potential new owner’s couch will fit in the living room or how a piece of artwork belonging to the potential new owner will look on a specific wall). Examples of the present disclosure could also be used to simulate renovations to the home (e.g., the addition of accessibility features, the removal of load bearing walls, the addition of a porch, etc.).

Such examples could also extend to virtual tours of hotel rooms and short term rental properties. For instance, examples of the present disclosure could be used to simulate the experience from a hotel room during different times of year or during different events (e.g., do leaves on the trees in the summer obstruct a view of the beach, how cold is it in the winter, or can noise from a nearby baseball stadium be heard from the room?).

Further examples of the present disclosure could be used in product design and manufacturing applications to emulate the results of various design changes. For instance examples of the present disclosure could be used in a vehicle design application to determine the effects of moving different components of a car (e.g., what would the car look like if the engine was moved to the back, how would that affect the balance, traction, and acceleration of the car, and what other parts might be needed to connect everything properly?).

Further examples of the present disclosure could be used in culinary applications to emulate the effects of different environmental conditions on a dish (e.g., what a particular dish will look like in different lighting, how fast ice cream is likely to melt when served in a particular location at a particular time, etc.).

Further examples of the present disclosure could be used to visualize the effects of time on an environment, utilizing historical records. For instance, the representation of a location could be modified over time and/or synchronized in real time to the actual location to show rain on one day, the damage from a hurricane on another day, or the like.

Further examples may include the adaptation of an environment and the items within the environment for alignment to certain cultural preferences or understandings of the user. For instance, although residents of the United States and the United Kingdom both speak English as a language, cultural expectations for an ideal sports experience may vary. For instance, some users may prefer a spectating environment with active shouting, singing, and a colorful stadium, while other users may prefer a more docile spectating environment that is more focused on the social context of the adjacent real or virtual uses. These preferences may be considered by the disclosed method in the detection of conditions (e.g., as in step 206 of the method 200) and the implementation of modifications (e.g., as in step 212 of the method 200). In both instances, these modifications may be retrieved from prior user-driven modifications of the environment.

Examples of the present disclosure could also be extended to aggregate multiple virtual effects that have been applied in the same target environment for other users to select and apply arbitrarily. For instance, if a plurality of immersions have been created to simulate the effects of a natural disaster in Times Square, other users could select which of these immersions to apply to an extended reality environment that depicts Times Square. Alternatively, a parallel simulation of all of the immersions could be presented in a manner similar to the use of image filters in social media.

Further examples of the present disclosure could utilize existing cooperative editing and inspection techniques to simplify the modification and update of extended reality environments. For instance, virtual assistants could be integrated with examples of the present disclosure to simply the manner in which user inputs are captured and interpreted or to allow for different modalities of input such as voice, gestures, visual examples, and the like.

Furthermore, the quality of the extended reality environments that are presented may be varied based on the availability of hardware for graphic computing, display, and system performance (e.g., image resolution capabilities, availability of high polygon meshes or photorealistic rendering, etc.).

FIG. 4 depicts a high-level block diagram of a computing device specifically programmed to perform the functions described herein. For example, any one or more components or devices illustrated in FIG. 1 or described in connection with the method 200 may be implemented as the system 400. For instance, a server (such as might be used to perform the method 200) could be implemented as illustrated in FIG. 4.

As depicted in FIG. 4, the system 400 comprises a hardware processor element 402, a memory 404, a module 405 for merging multiple environments to create a single, cohesive extended reality environment, and various input/output (I/O) devices 406.

The hardware processor 402 may comprise, for example, a microprocessor, a central processing unit (CPU), or the like. The memory 404 may comprise, for example, random access memory (RAM), read only memory (ROM), a disk drive, an optical drive, a magnetic drive, and/or a Universal Serial Bus (USB) drive. The module 405 for merging multiple environments to create a single, cohesive extended reality environment may include circuitry and/or logic for performing special purpose functions relating to the operation of a home gateway or XR server. The input/output devices 406 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for merging multiple environments to create a single, cohesive extended reality environment (e.g., a software program comprising computer-executable instructions) can be loaded into memory 404 and executed by hardware processor element 402 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for merging multiple environments to create a single, cohesive extended reality environment (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
acquiring, by a processing system including at least one processor, a virtual item to be inserted into a target environment to create an extended reality environment;
detecting, by the processing system, conditions within the target environment;
merging, by the processing system, the virtual item and the target environment to create the extended reality environment, wherein the merging includes modifying at least one of: the virtual item or the target environment based on the conditions within the target environment; and
presenting, by the processing system, the extended reality environment to a user.

2. The method of claim 1, wherein the target environment comprises a real word environment.

3. The method of claim 1, wherein the target environment comprises a virtual environment.

4. The method of claim 3, wherein the virtual environment comprises a digital twin of a real world environment.

5. The method of claim 1, wherein the detecting comprises analyzing data collected by a sensor located within the target environment.

6. The method of claim 1, wherein the detecting comprises estimating the conditions based on historical data relating to the target environment.

7. The method of claim 1, wherein the detecting comprises estimating the conditions based on historical data relating to other environments that are similar to the target environment.

8. The method of claim 1, wherein the conditions comprise physical boundaries of the target environment, dimensions of the target environment, and a layout of the target environment.

9. The method of claim 1, wherein the conditions comprise environmental conditions within the target environment.

10. The method of claim 1, wherein the modifying comprises at least one of: a geometry merge, a scaling, a color adjustment, or a texture smoothing so that a transition from the virtual item to the target environment appears more natural.

11. The method of claim 1, wherein the modifying comprises modifying the at least one of: the virtual item or the target environment to match a specified time period.

12. The method of claim 1, wherein the modifying comprises modifying the at least one of: the virtual item or the target environment to match specified environmental conditions.

13. The method of claim 1, further comprising:
receiving, by the processing system in response to the presenting, a user modification to the extended reality environment.

14. The method of claim 13, wherein the user modification comprises at least one of: a request to modify a visual effect in the extended reality environment, a request to modify a virtual object in the extended reality environment, a request to modify a speed with an effect that is applied to the extended reality environment, a request to change an initial appearance of the virtual item, or a request to change a final appearance of the virtual item.

15. The method of claim 13, further comprising:
storing the user modification for reuse in another extended reality environment.

16. The method of claim 1, further comprising:
updating, by the processing system in response to a change in at least one of the virtual item or the target environment, the extended reality environment.

17. The method of claim 16, wherein the updating comprises replicating a change to a digital twin of the at least one of: the virtual item or the target environment.

18. The method of claim 16, wherein the updating comprises changing an environmental condition in the extended reality environment to reflect a passage of time.

19. A non-transitory computer-readable medium storing instructions which, when executed by a processing system including at least one processor, cause the processing system to perform operations, the operations comprising:
acquiring a virtual item to be inserted into a target environment to create an extended reality environment;
detecting conditions within the target environment;
merging the virtual item and the target environment to create the extended reality environment, wherein the merging includes modifying at least one of: the virtual item or the target environment based on the conditions within the target environment; and
presenting the extended reality environment to a user.

20. A device comprising:
a processing system including at least one processor; and
a computer-readable medium storing instructions which, when executed by the processing system, cause the processing system to perform operations, the operations comprising:
acquiring a virtual item to be inserted into a target environment to create an extended reality environment;
detecting conditions within the target environment;
merging the virtual item and the target environment to create the extended reality environment, wherein the merging includes modifying at least one of: the virtual item or the target environment based on the conditions within the target environment; and
presenting the extended reality environment to a user.
